(19) United States
(12) Patent Application Publication
(10) Pub. No.: US 2010/0214278 A1
(43) Pub. Date: Aug. 26, 2010

(54) ELECTRONIC DEVICE

(75) Inventor: Hiroaki Miura, Yokohama-shi (JP)

Correspondence Address: MORRISON & FOERSTER LLP, 12531 HIGH BLUFF DRIVE, SUITE 100, SAN DIEGO, CA, 92130-2040, US

(73) Assignee: Kyocera Corporation, Kyoto (JP)

(21) Appl. No.: 12/671,199

(22) PCT Filed: Jul. 30, 2008
(86) PCT No.: PCT/JP2008/063706

§ 371 Date: Apr. 15, 2010

(30) Foreign Application Priority Data
Jul. 30, 2007 (JP) 2007-197712

(51) Int. Cl. G06F 3/038

(52) U.S. Cl. 345/212

(57) ABSTRACT

To provide an electronic device in which information about an application that is in a non-active state can be displayed during a power saving mode and an operation mode can be changed from the power saving mode to a normal power mode with a pressing operation of a predetermined key. When a plurality of applications are activated and a multi-window is displayed, a mode of a window display area with respect to the application that is in a visible state and in a non-active state is changed to ‘power saving mode 1’ (power saving screen with a character) and after that, it is changed to ‘power saving mode 2’ (complete power saving screen).

### TECHNICAL FIELD

The present invention relates to an electronic device that can activate a plurality of applications.

### BACKGROUND ART

Conventionally, in an electronic device such as a mobile terminal device, control is performed such that a display area of a display unit is split into a first area and a second area, information on applications is displayed on the first area, and information on a reception level of radio waves and battery charge is displayed on the second area.

Here, a display unit has been proposed, in which organic EL (Electro Luminescence) is employed in the display unit, and electric energy to be supplied to the first area and the second area is controlled depending on circumstances, thereby reducing power consumption (for example, refer to Patent Document 1).

Moreover, some electronic devices have a function whereby a plurality of applications are activated by operations of an operation unit, a plurality of windows for the respective applications are displayed on a display unit at the same time (multiwindow display), and when any one of the plurality of windows is switched to an active state, all the other windows are switched to an inactive state.

Patent Publication 1: Japanese Unexamined Patent Application, First Publication No. 2000-105573

### DISCLOSURE OF THE INVENTION

### Problems to be Solved by the Invention

Incidentally, in a case in which a plurality of applications are activated, and the windows for the respective applications are split and displayed, and when a display mode of a window in an inactive state is switched from a normal power mode to a power saving mode (multiwindow power saving mode) after a predetermined period of time has elapsed, the applications for the windows in an inactive state do not accept an input by way of a depressing operation of a key disposed to the operation unit; therefore, it has been impossible to cancel the power saving mode by way of the depressing operation of the key. Here, the power saving mode refers to a display mode for suppressing electric power consumption by controlling a screen display such as by darkening the screen display or turning off at least a part of the screen display. Moreover, the normal power mode refers to a display mode other than the power saving mode.

Accordingly, the present invention has been made in view of the problems as described above, and provides an electronic device that can cancel a power saving display by way of a predetermined operation when windows are displayed in the power saving mode so as to respectively correspond to a plurality of activated applications.

### Means for Solving the Problems

In order to solve the abovementioned problems, an electronic device according to the present invention includes: a display unit; an operation unit; an application control unit that controls activation of a plurality of applications; and a display control unit that displays, on the display unit, a display window related to the application activated by the application control unit, in which the display control unit has: a first control unit that displays a first display window for a first application and a second display window for a second application when the first application and the second application are activated by the application control unit, and display one of the display windows in a first power saving state in relation to another of the display windows when any one of the first display window and the second display window is in an inactive state; and a second control unit that cancels the display of the one of the display windows in the first power saving state when the one of the display windows is displayed in the first power saving state, and a predetermined operation is performed to the operation unit.

Moreover, in the electronic device, it is preferable that the display control unit displays, on the display unit, information related to an application corresponding to the one of the display windows when the one of the display windows is displayed in the first power saving state.

In addition, in the electronic device, it is preferable that the display control unit displays, as the information, a name of the application corresponding to the one of the display windows.

Furthermore, in the electronic device, it is preferable that the display control unit cancels the display of the information after a first predetermined period of time has elapsed since the one of the display windows was switched to the inactive state.

Moreover, in the electronic device, it is preferable that the display control unit displays the one of the display windows in the first power saving state after a second predetermined period of time has elapsed since the one of the display windows was switched from an active state to the inactive state.

In addition, in the electronic device, it is preferable that the display control unit displays the one of the display windows in a second power saving state that is a higher level of power saving than the first power saving state after a third predetermined period of time has elapsed since the one of the display windows was displayed in the first power saving state.

Furthermore, in the electronic device, it is preferable that the display unit is configured such that a display area thereof can be split into a plurality of display areas, and the display control unit displays the first display window and the second display window in one area of the plurality of display areas thus split, respectively.

Moreover, in the electronic device, it is preferable that the applications include at least one of a mail creating application, a mail browsing application, and a TV broadcast reception displaying application.

In addition, in the electronic device, it is preferable that the display unit is an organic EL (Electro Luminescence) display.

Furthermore, in the electronic device, it is preferable that the display control unit displays the one of the display windows in the first power saving state by performing black display in the display area of the one of the display windows.

Moreover, in the electronic device, it is preferable that the second control unit cancels the display of the one display window in the first power saving state, when at least one operation among a predetermined order of one or a plurality of keys, a short operation of a particular key, a long operation of a particular key, or simultaneous operations of a plurality of keys, or a predetermined combined operation thereof are performed to the operation unit, as the predetermined operation.

### Effects of the Invention

According to the present invention, when windows are displayed in a power saving mode so as to respectively correspond to a plurality of activated applications, the power saving display can be cancelled by way of a predetermined operation.

### BRIEF DESCRIPTION OF THE DRAWINGS

FIG. 1 is a perspective view showing an appearance of an electronic device according to the present invention;

FIG. 2 is a block diagram showing functions of the cellular telephone device according to the present invention;

FIG. 3 is a diagram showing a changing aspect of a screen display when a normal power mode is switched to a power saving mode;

FIG. 4 is a timing diagram showing operations to switch from the power saving mode to the normal power mode;

FIG. 5 is a diagram of a first embodiment showing a changing aspect of the screen display when the normal power mode is switched to the power saving mode;

FIG. 6 is a flowchart for illustrating operations when the screen display is switched to multiwindow;

FIG. 7 is a flowchart for illustrating operations when the screen display that has been switched to the multiwindow is switched to a power saving mode 1;

FIG. 8 is a flowchart for illustrating operations when the screen display that has been switched to the power saving mode 1 is switched to a power saving mode 2;

FIG. 9 is a flowchart for illustrating operations when the screen display that has been switched to the power saving mode is switched to a normal power mode; and

FIG. 10 is diagram showing a changing aspect of the screen display in a second embodiment of the electronic device according to the present invention.

### EXPLANATION OF REFERENCE NUMERALS

1 cellular telephone device
11 operation unit
21 organic EL display unit (display unit)
47 CPU (application control unit, first control unit, second control unit)

### PREFERRED MODE FOR CARRYING OUT THE INVENTION

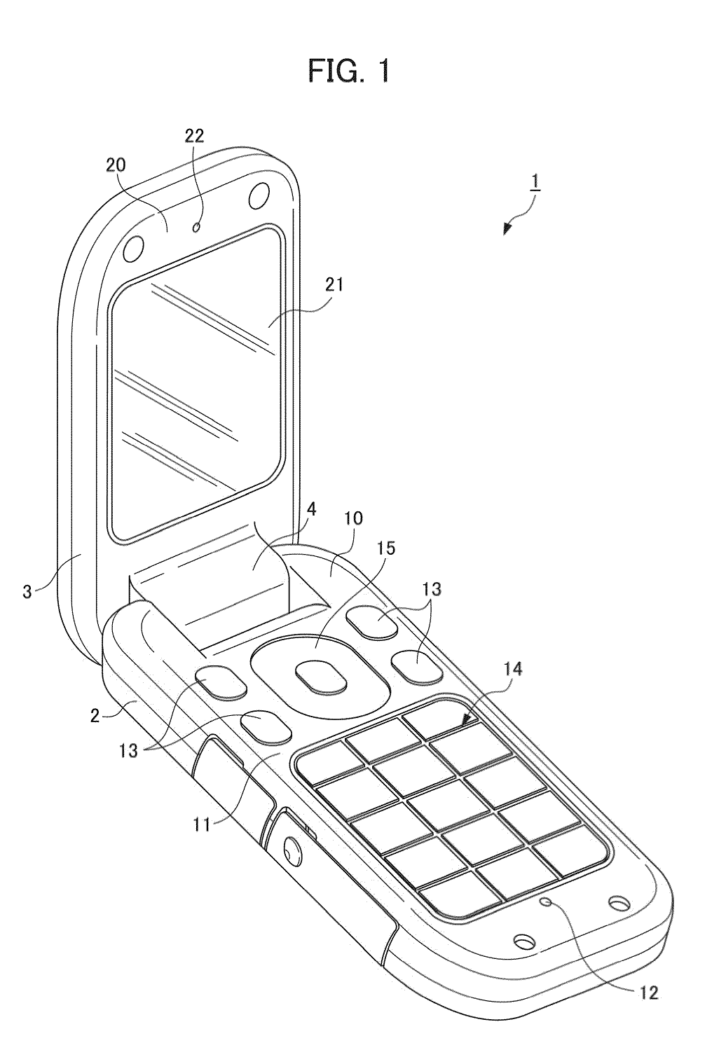

A description is provided hereinafter for embodiments of the present invention. FIG. 1 is a perspective view showing an appearance of a cellular telephone device 1 as an example of an electronic device according to the present invention. It should be noted that, although FIG. 1 shows a so-called flip-type cellular telephone device, the present invention is not limited thereto. For example, it may be a slider type in which one of the bodies slides to one direction in a state in which the bodies are mutually superimposed; a rotating (turning) type in which one of the bodies is rotated around an axis line along the direction in which the bodies are superimposed; and a type (straight type) in which an operation unit and a display unit are disposed in one body without having a connecting portion.

The cellular telephone device 1 is configured to include an operation unit body 2 and a display unit body 3. The operation unit body 2 is configured to include on a front face portion 10 thereof an operation unit 11 and a microphone 12 to which sound, which a user of the cellular telephone device 1 produces during a phone call, is input. The operation unit 11 is configured with: feature setting operation buttons 13 for operating various settings and various features such as a telephone number directory feature and a mail feature; input operation buttons 14 for inputting digits of a telephone number and characters for mail, and a selection operation button 15 that performs selection of the various operations and scrolling.

Moreover, the display unit body 3 is configured to include, on a front face portion 20, an organic EL (Electro Luminescence) display unit 21 for displaying a variety of information, and a speaker 22 for outputting sound of the other party of the conversation.

Here, a configuration of the organic EL display unit 21 is described. The organic EL is a self-luminous display device, in which anode electrodes composed of ITO (Indium Tin Oxide) are formed on a glass substrate, and an organic layer composed of a hole transport layer, a luminescent layer and an electron transport layer, and cathode electrodes composed of metal electrodes are formed thereupon.

Here, in the organic EL display unit 21, a brightness value is controlled by an amount of electric current applied to the organic layer. Moreover, the organic EL display unit 21 is characterized in that black display is performed by keeping the luminescent layer from emitting light, i.e. by not applying an electric current to the organic layer; therefore, the portion not emitting light is completely in a state of being black, and the contrast is very high.

In addition, an upper end portion of the operation unit body 2 and a lower end portion of the display unit body 3 are connected via a hinge mechanism 4. Furthermore, the cellular telephone device 1 can be in a state where the operation unit body 2 and the display unit body 3 are apart from each other (opened state), and in a state where the operation unit body 2 and the display unit body 3 are contacting each other (folded state), as the operation unit body 2 and the display unit body 3, connected via the hinge mechanism 4, pivot with respect to each other.

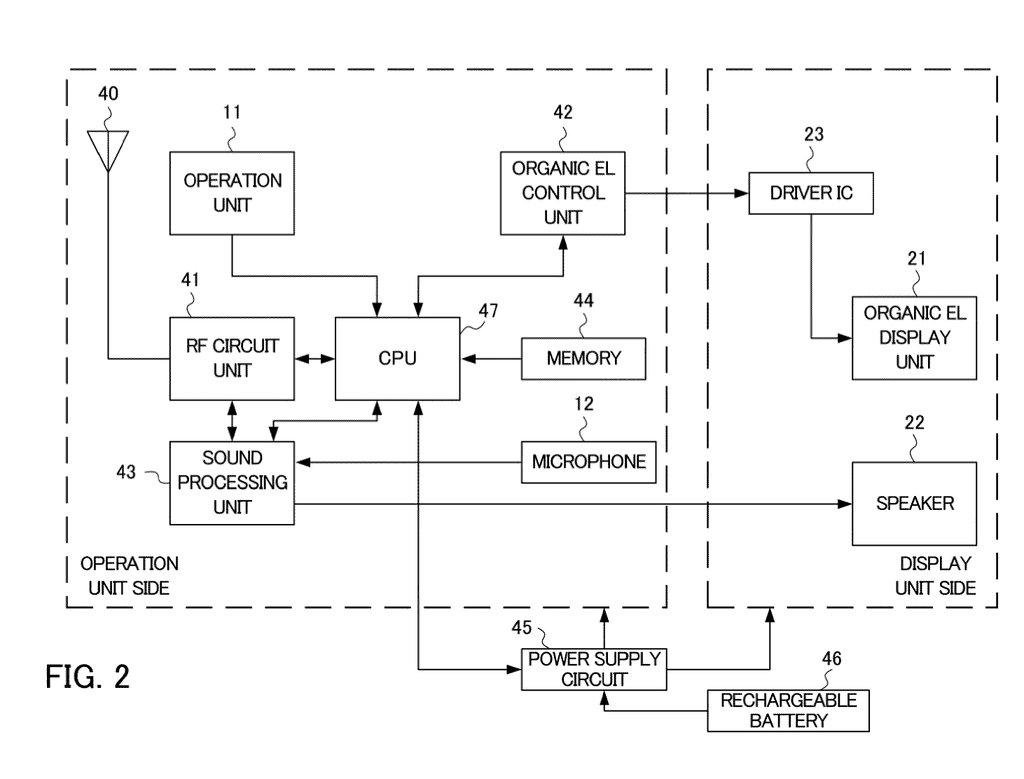

Next, FIG. 2 is a functional block diagram showing functions of the cellular telephone device 1. As shown in FIG. 2, in the cellular telephone device 1, the operation unit 11, the microphone 12, a main antenna 40, an RF circuit unit 41, an organic EL control unit 42, a sound processing unit 43, memory 44, a power supply circuit unit 45, a rechargeable battery 46, and a CPU 47 are provided to the operation unit side; and an organic EL display unit 21, the speaker 22, and a driver IC 23 are provided to the display unit side.

The main antenna 40 communicates with external devices by way of a predetermined usable frequency band (for example, 800 MHz). It should be noted that, although the predetermined usable frequency band is set to 800 MHz in the present embodiment, other frequency bands can also be used. In addition, the main antenna 40 can be configured as a so-called dual band compatible antenna that can correspond to another usable frequency band (for example, 2 GHz) in addition to the predetermined usable frequency band.

The RF circuit unit 41 performs demodulation processing of a signal received by the main antenna 40, transmits the processed signal to the CPU 47, performs modulation processing of a signal received from the CPU 47, and transmits the processed signal to an external device (base station) via the main antenna 40.

The organic EL control unit 42 performs predetermined image processing in accordance with control by the CPU 47, and outputs the processed image data to the driver IC 23. The driver IC 23 stores the image data, which is transmitted from the organic EL control unit 42, in frame memory so as to be output to the organic EL display unit 21 at predetermined timing.

The sound processing unit 43 performs predetermined sound processing in accordance with control by the CPU 47 for a signal transmitted from the RF circuit unit 41, and outputs the processed signal to the speaker 22. The speaker 22 externally outputs the signal that is transmitted from the sound processing unit 43.

Moreover, the sound processing unit 43 processes a signal, which is input from the microphone 12, in accordance with control by the CPU 47, and outputs the processed signal to the RF circuit unit 41. The RF circuit unit 41 performs predetermined processing for the signal transmitted from the sound processing unit 43, and outputs the processed signal to the main antenna 40.

The memory 44 is, for example, working memory, and is utilized for arithmetic processing by the CPU 47.

The power supply circuit unit 45 converts a power supply voltage, which is supplied from the rechargeable battery 46, into a predetermined power voltage, and supplies the converted power supply voltage to the organic EL display unit 21 and the like.

The CPU 47 controls the entirety of the cellular telephone device 1, and performs predetermined control particularly for the RF circuit unit 41, the organic EL control unit 42 and the sound processing unit 43.

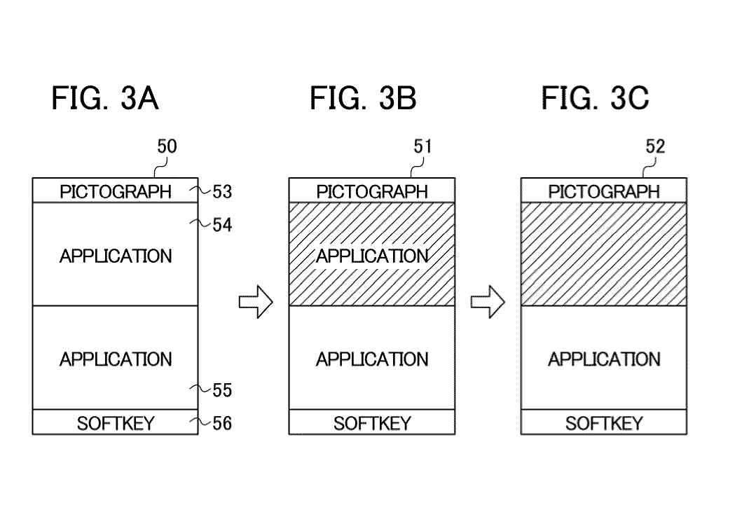

Next, with reference to FIG. 3, a description is provided for a changing aspect of a screen display 50 of the organic EL display unit 21 when the organic EL display unit 21 is switched from the normal power mode to the power saving mode by control of the CPU 47.

The CPU 47 is configured with an application control unit and a display control unit. The application control unit controls activation of a plurality of applications. Moreover, the display control unit is configured with a first control unit and a second control unit. In a case in which a first application and a second application are activated at the same time by the application control unit, the first control unit displays a first display window for the first application and a second display window for the second application on the organic EL display unit 21, and in a case in which any one of the first display window and the second display window is in an inactive state, the first control unit displays the one display window in a first power saving state in relation to the other display window. In a case in which one display window is displayed in the first power saving state, and when a predetermined operation is performed on the operation unit 11, the second control unit cancels the display of the one display window in the first power saving state.

With such a configuration, in the power saving mode in which one display window in an inactive state is displayed in a power saving manner in relation to the other display window in an active state, the cellular telephone device 1 can switch the power saving mode to the normal power mode by way of a predetermined operation.

Moreover, in a case in which one display window is displayed in the first power saving state, it is preferable that the display control unit displays information on the application corresponding to the one display window on the display unit. In particular, the information should be displayed on the one display window.

With such a configuration, in the first power saving state, the cellular telephone device 1 can visually present application information to the user without involving other operations.

In addition, it is preferable that the display control unit displays, as the information, a name of the application corresponding to the one display window.

With such a configuration, in the first power saving state, the cellular telephone device 1 can visually present an application name to the user without involving other operations.

Furthermore, it is preferable that the display control unit cancels the display of the information after a first predetermined period of time t1 has elapsed since the one display window was switched to an inactive state.

With such a configuration, in the cellular telephone device 1, the display of information on an application is canceled after the first predetermined period of time has elapsed, and therefore it is possible to achieve power saving.

Moreover, it is preferable that the display control unit displays the one display window in the first power saving state after a second predetermined period of time t2 has elapsed since the one display window was switched from an active state to an inactive state.

With such a configuration, in the cellular telephone device 1, transition to the first power saving state is not performed until the second predetermined period of time t2 has elapsed since switching to an inactive state, and therefore, in a case in which an application in an inactive state is operated by the user before the second predetermined period of time t2 elapsed, state transition (state transition from the first power saving state to the normal state) is not performed, and the application is activated without a delay.

In addition, it is preferable that the display control unit displays the one display window in a second power saving state that is a higher level of power saving than the first power saving state after a third predetermined period of time t3 has elapsed since the one display window was displayed in the first power saving state.

Here, with higher standby electric power in the power saving state, less time and electric power are required for activation of an application. Therefore, with such a configuration, in the cellular telephone device 1, the power saving state is controlled stepwise in accordance with an elapsed time, thereby making it possible to achieve efficiency in activation and time of an application in the power saving state.

Furthermore, the organic EL display unit 21 is configured such that the display area thereof can be split into a plurality of areas, and it is preferable that the display control unit displays each of the first display window and the second display window in one of the plurality of display areas thus split.

With such a configuration, in the cellular telephone device 1, windows are not displayed in a superimposed manner, thereby making it possible to provide a display that is easy to browse by the user.

Moreover, the applications include at least one of a mail creating application, a mail browsing application, and a TV broadcast reception displaying application.

In addition, it is preferable that the display control unit displays one display window in the first power saving state by performing black display in the display area of the one display window.

With such a configuration, in the cellular telephone device 1, a power saving effect can be achieved.

Furthermore, it is preferable that the second control unit cancels the display of the one display window in the first power saving state, when operations in a predetermined order of one or a plurality of keys, a short operation of a particular key, a long operation of a particular key, or at least any one operation among simultaneous operations of a plurality of keys, or operations of a predetermined combination thereof are performed as a predetermined operation to the operation unit 11.

With such a configuration, in the cellular telephone device 1, it is possible to cancel a display in the first power saving state by way of a simple operation.

It should be noted that it is assumed in the following that the first application (hereinafter referred to as an application A) and the second application (hereinafter referred to as an application B) are activated, and an area for displaying a window 54 (the first display window) related to the application A and an area for displaying a window 55 (the second display window) related to the application B are displayed as a vertically split screen (multiwindow) on the screen display 50. Moreover, a pictograph area 53, which indicates a state of received radio wave strength as well as charge of the rechargeable battery 46, is displayed in an upper end portion of the screen display 50, and in addition, a softkey area 56, which schematically indicates functions of keys arranged in the operation unit 11, is displayed in the lower end portion of the screen display 50.

Furthermore, FIG. 3A is the screen display 50 in the normal power mode; FIG. 3B is a screen display 51 in a power saving mode 1 (the first power saving state); and FIG. 3C is a screen display 52 in a power saving mode 2 (the second power saving state).

Moreover, in FIG. 3A, the application B is an application that is currently used by the user, and is in a visible and active state; whereas, the application A is an application that is not currently used by the user, and is in a visible and inactive state. It should be noted that, in the present embodiment, the visible state refers to a state in which the display can be updated; the active state refers to a state in which key notification can be accepted; and the inactive state refers to a state in which key notification can not be accepted.

Here, the window 54 related to the application A that is not used is in the visible state, and thus a power supply voltage is wastefully consumed. Accordingly, a configuration is conceivable in which the display area of the window 54 is switched to black display to serve as a power saving screen. However, when the display area of the window 54 is switched to black display, a state of the application in the inactive state becomes unknown.

An objective of the present invention is to switch a display area of a window related to an application in an inactive state to a power saving screen, while easily confirming a state of the application in the inactive state. It should be noted that the organic EL display unit 21 enters a power saving state when switched to black display due to the aforementioned characteristics thereof.

Here, when a predetermined period of time t1 has elapsed since the application B transitioned into the visible and active state, the CPU 47 performs control such that the display area of the window 54 related to the application A that has transitioned into the visible and inactive state is switched from the normal power mode to the power saving mode 1 (refer to FIG. 3B). It should be noted that the CPU 47 monitors a lapse of the predetermined period of time t1 based on time information obtained from a clock unit (not shown).

Moreover, the power saving mode 1 is a mode in which the display area of the window 54 is switched to black display for reducing power consumption, and information on the application A (for example, the name “application A” of the application A) is displayed on the window 54. According to this power saving mode 1, the power saving screen includes characters, and therefore the power consumption of the display area of the window 54 related to the application A in the inactive state can be reduced, while the application A in the inactive state can be confirmed at a glance.

Furthermore, when a predetermined period of time (the second predetermined period of time) t2 has elapsed since transitioning to the power saving mode 1, the CPU 47 controls such that the display area of the window 54 related to the application A is switched from the power saving mode 1 to the power saving mode 2 (refer to FIG. 3C). It should be noted that the CPU 47 monitors a lapse of the predetermined period of time t2 based on time information obtained from the clock unit (not shown).

The power saving mode 2 is a mode in which the display area of the window 54 is completely switched to black display. According to this power saving mode 2, it is possible to greatly reduce power consumption for the display area of the window 54 related to the application A in the inactive state.

Moreover, in the prior art, in a case in which a power saving mode is established, it is switched to the normal power mode by canceling the power saving mode by way of event notification; however, the cancellation can not be easily performed by the user at an arbitrary timing.

Accordingly, the CPU 47 according to the present invention performs control such that when a predetermined operation such as a depressing operation of a particular key of the operation unit 11 is performed by the user at an arbitrary timing, a display area that has transitioned to the power saving mode 1 or the power saving mode 2 is switched to the normal power mode.

With such a configuration, when switching from the power saving mode to the normal power mode, the switching processing can be performed without complicated operations.

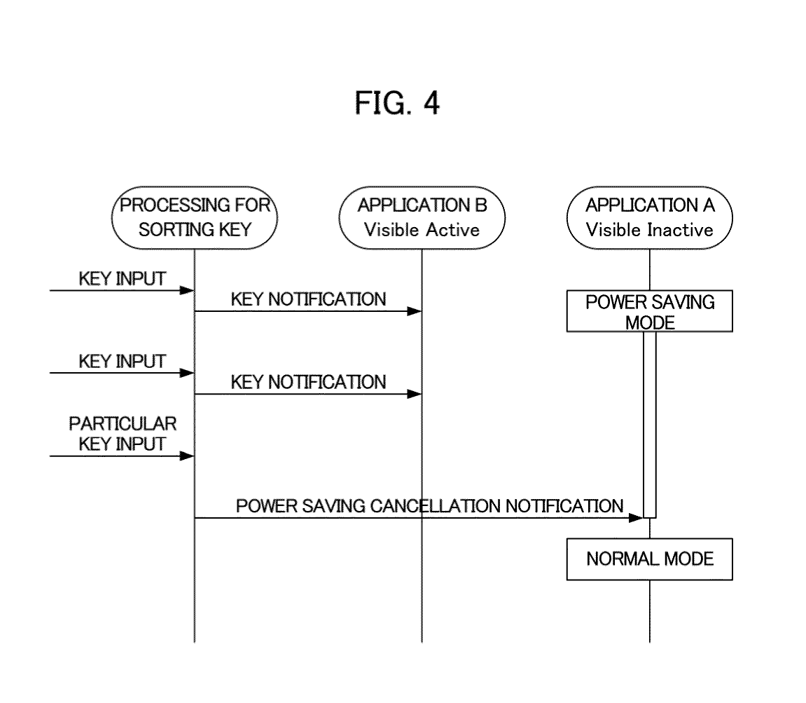

Next, with reference to a timing diagram shown in FIG. 4, an operation is described in which the screen display of the window is switched from the power saving mode to the normal power mode when the user performs a depressing operation of a particular key of the operation unit 11 at an arbitrary timing. It should be noted that the CPU 47 is assumed to have an application manager function, and is assumed to be able to access the application A and the application B. Moreover, the application manager functions include a function to manage states of applications such as a visible state and an active state, and a function to make notification of an application key.

When the user performs a depressing operation of a key of the operation unit 11, the CPU 47 detects the depression of the key, and performs processing for sorting the key. In a case in which the CPU 47 detects depression of a particular key by the user, the CPU 47 makes power saving cancellation notification to the application A, and performs switching processing from the power saving mode 1 or the power saving mode 2 to the normal power mode for the display area of the window 54 related to the application A, thereby canceling the display of the one window 54 in the power saving state.

In addition, in a case in which the CPU 47 detects depression of a key other than the particular key, the CPU 47 makes normal key notification to the application B, and controls the application B in accordance with the depressed key.

In this way, when the user performs a depressing operation of a particular key of operation unit 11 at an arbitrary timing, the display area of the window related to the application in the inactive state, which has been switched to the power saving mode, can be switched to the normal power mode.

### FIRST EMBODIMENT

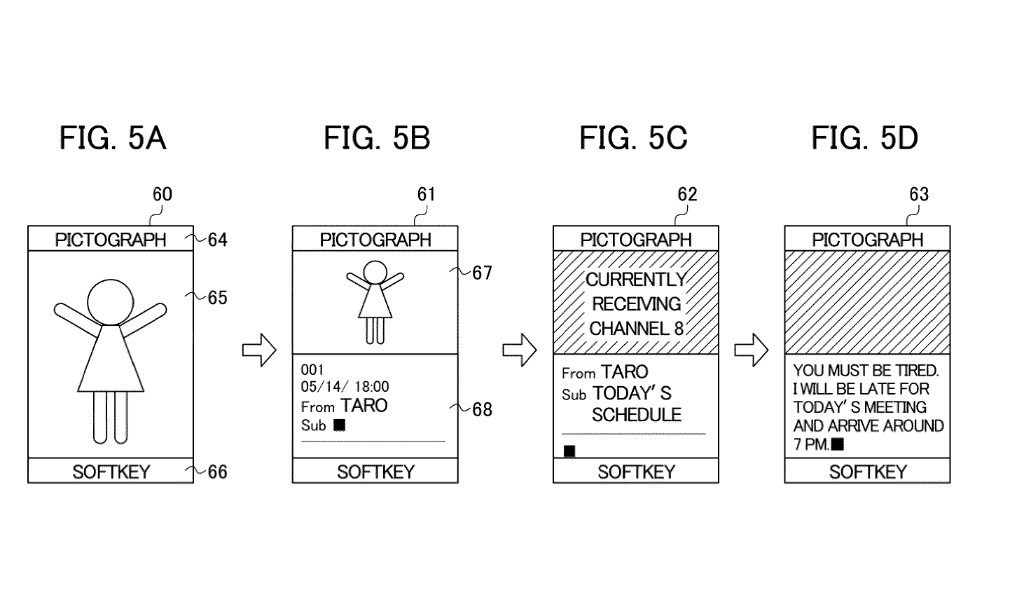

A first embodiment of the electronic device according to the present invention is hereinafter described. FIG. 5 is a sequence of screen displays in which a TV broadcast reception displaying application is activated, and thereafter a mail creating application is activated. In the screen display 60 as shown in FIG. 5A, the TV broadcast reception displaying application is activated, and the entire display area of the window is used to display the TV broadcast. Next, in a screen display 61 as shown in FIG. 5B, since the mail creating application is further activated, windows of the two applications are displayed as a split screen. Here, the TV broadcast reception displaying application is visible and inactive, and the mail creating application is currently used and thus is visible and active.

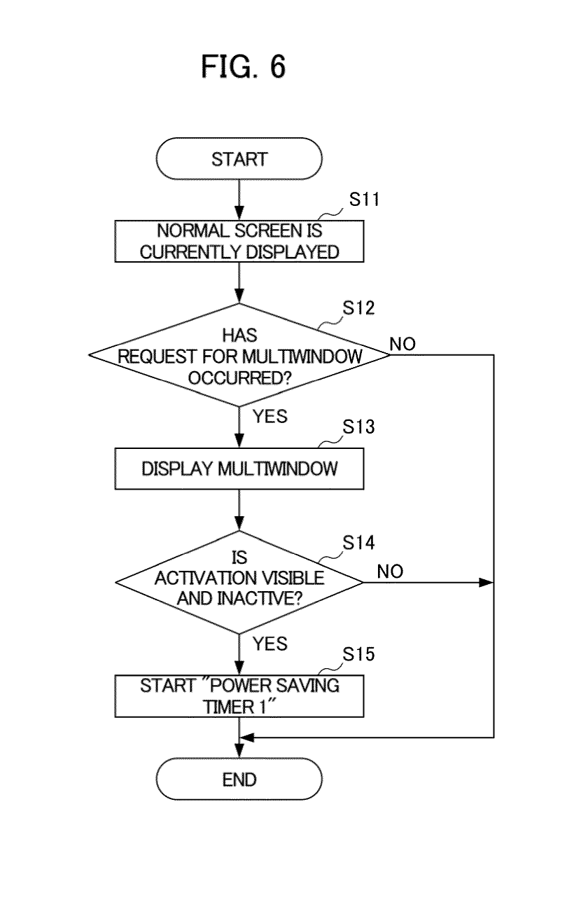

Here, a flow when the screen display of the window is switched from the screen display 60 to the screen display 61 is described with reference to a flowchart shown in FIG. 6.

In Step S11, in response to an operation by the user, the CPU 47 displays a window 65 related to the TV broadcast reception displaying application in the normal power mode on the entire organic EL display unit 21 (refer to FIG. 5A).

In Step S12, the CPU 47 determines whether multiwindow display is required. In a case in which the multiwindow display is required, i.e. in a case in which activation of other applications is required, the processing proceeds to Step S13. It should be noted that, in this step, the CPU 47 determines that activation of the mail creating application is required based on the operation by the user.

In Step S13, the CPU 47 causes multiwindow to be displayed on the organic EL display unit 21. As shown in FIG. 5B, the CPU 47 displays a window 67 related to the TV broadcast reception displaying application in an upper half of the screen display 61, and displays a window 68 related to the mail creating application in a lower half of the screen display 61.

In Step S14, the CPU 47 determines whether each multiwindow displayed on the organic EL display unit 21 is visible and inactive. In a case in which there is a visible and inactive window, the processing proceeds to Step S15. It should be noted that, in the present embodiment, the TV broadcast reception displaying application is visible and inactive.

In Step S15, the CPU 47 activates a “power saving timer 1”, and monitors a lapse of a predetermined period of time (the second predetermined period of time) t1.

Next, according to the activation of the mail application program, the windows concerning two application programs of the TV broadcast reception displaying application and the mail creating application is displayed attended with vertical division (refer to FIG. 5B). When a predetermined period of time t1 has elapsed since the windows were displayed, the CPU 47 switches the display area of the window 67 related to the TV broadcast reception displaying application being visible and inactive from the normal power mode to the power saving mode 1, and displays information on the TV broadcast reception displaying application (“currently receiving channel 8” in this case) on the window 67 (refer to FIG. 5C).

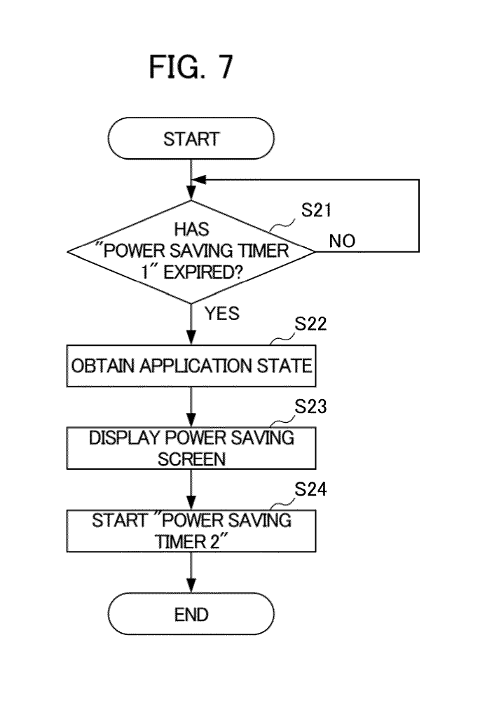

Here, a flow when the screen display of the window is switched from the screen display 61 to the screen display 62 is described with reference to a flowchart shown in FIG. 7.

In Step S21, the CPU 47 determines whether the predetermined period of time t1 has elapsed, by way of the “power saving timer 1” activated in Step S15. In a case in which it is determined by way of the “power saving timer 1” that the predetermined period of time t1 has elapsed, the processing proceeds to Step S22.

In Step S22, the CPU 47 obtains a state of the application. More specifically, the CPU 47 obtains a state of the visible and inactive TV broadcast reception displaying application (for example, channel 8 is activated and the like).

In Step S23, the CPU 47 switches the display area from the normal power mode to the power saving mode 1. More specifically, the CPU 47 switches the display area of the window 67 related to the TV broadcast reception displaying application from the normal power mode to the power saving mode 1, and displays information on the TV broadcast reception displaying application (“currently receiving channel 8” in this case) on the window 67 (refer to FIG. 5C).

In Step S24, the CPU 47 activates a “power saving timer 2”, and monitors a lapse of a predetermined period of time (the first predetermined period of time, the third predetermined period of time) t2.

Next, when the predetermined period of time t2 has elapsed since the information on the TV broadcast reception displaying application was displayed (the screen display 62), the CPU 47 switches the visible and inactive display area of the window 67 related to the TV broadcast reception displaying application from the power saving mode 1 (display in the first power saving state) to the power saving mode 2 (display in the second power saving state), and completely switches the window 67 to black display (refer to FIG. 5D).

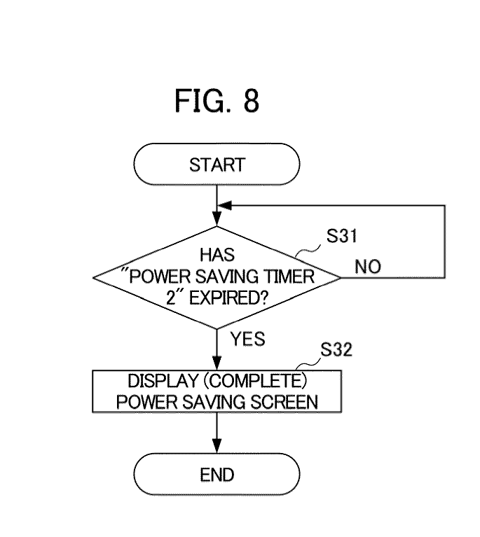

Here, a flow when the screen display of the window is switched from the screen display 62 to the screen display 63 is described with reference to the flowchart shown in FIG. 8.

In Step S31, the CPU 47 determines whether the predetermined period of time t2 has elapsed, by way of the “power saving timer 2” activated in Step S24. In a case in which it is determined by way of the “power saving timer 2” that the predetermined period of time t2 has elapsed, the processing proceeds to Step S32.

In Step S32, the CPU 47 switches the display area from the power saving mode 1 to the power saving mode 2. More specifically, the CPU 47 switches the display area of the window 67 related to the TV broadcast reception displaying application from the power saving mode 1 to the power saving mode 2, and completely switches the window 67 to black display (refer to FIG. 5D). In this way, the window 54 related to the application A in the inactive state is displayed in the power saving state (the first power saving state, and the second power saving state) in relation to the window 55 related to the application B in the active state, thereby making it possible to achieve a reduction of power consumption.

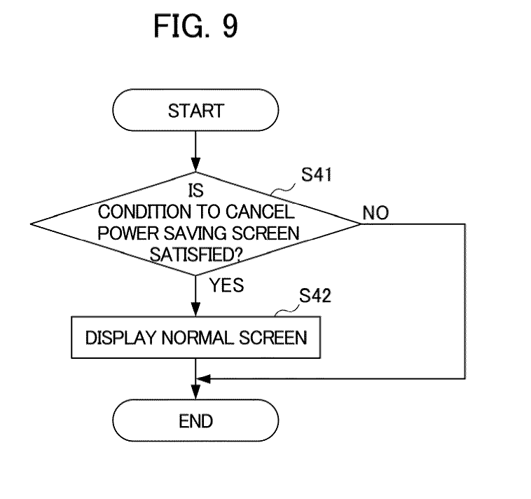

Moreover, a flow when the screen display of the window is switched from the screen display 62 (the power saving mode 1) or the screen display 63 (power saving mode 2) to the screen display 61 (the normal power mode) is described with reference to a flowchart shown in FIG. 9. It should be noted that, in the present embodiment, it is assumed that the display area of the window 67 related to the TV broadcast reception displaying application has been switched to the power saving mode 1 (Step S23) or the power saving mode 2 (Step S32).

In Step S41, the CPU 47 determines whether a condition to cancel the power saving mode 1 or the power saving mode 2 is satisfied. Here, the condition to cancel the power saving mode is a condition in which, at least one operation among a depressing operation of one or a plurality of keys in a predetermined order, a short depressing operation of a particular key, a long depressing operation of a particular key, and simultaneous depressing operations of a plurality of keys, or a predetermined combined operation thereof has been performed to the operation unit 11, as a predetermined operation. In a case in which the condition to cancel the power saving mode is satisfied, the processing proceeds to Step S42. It should be noted that the operation to the operation unit 11 may be an operation other than the depressing operation.

In Step S42, the CPU 47 cancels the power saving mode 1 or the power saving mode 2 to be switched to the normal power mode (refer to FIG. 5B). Moreover, after switching to the normal power mode in this step, the processing proceeds to Step S14.

In this way, according to the present invention, when a plurality of applications are activated, and multiwindow display is performed, the display area of the window related to the visible and inactive application is switched to the power saving mode 1 (the power saving screen with characters), and is thereafter switched to the power saving mode 2 (the complete power saving screen), and the display in the power saving state of the window 54 related to the application A in the inactive state is canceled; therefore, it is possible to notify the user of a state of the application at a glance, the user having forgotten the state of the visible and inactive application as time elapses, while achieving power-saving; and in a case in which a visible and active application is being used for a long time period, it is possible to achieve complete reduction of power consumption for the display area of the window related to the visible and inactive application.

In addition, according to the present invention, in a case in which the user performs a depressing operation of a particular key of the operation unit 11 at an arbitrary timing, the display area that has transitioned to the power saving mode 1 or the power saving mode 2 can be switched to the normal power mode.

### SECOND EMBODIMENT

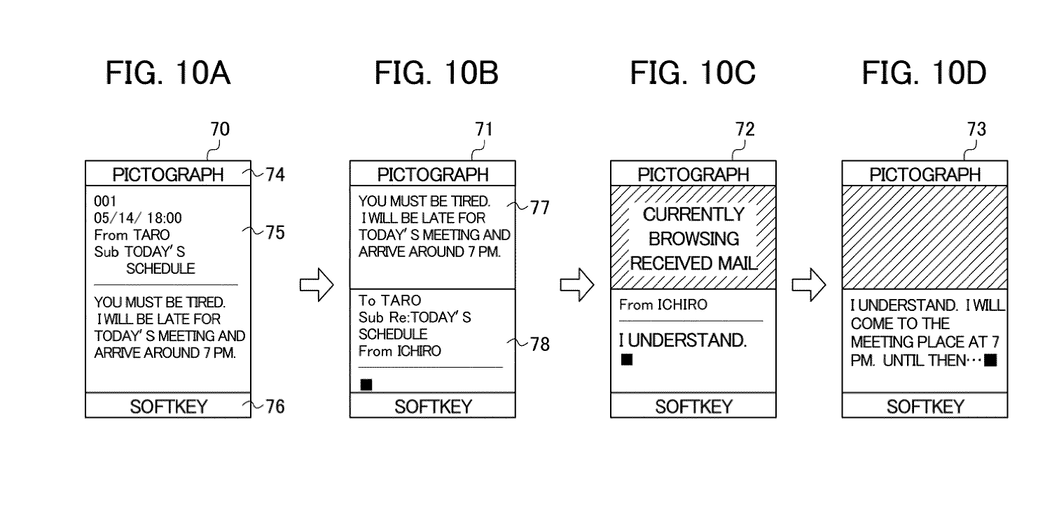

Next, a second embodiment of the electronic device according to the present invention is described. FIG. 10 is a sequence of screen displays in which a mail browsing application is activated, and thereafter a mail creating application is activated.

In the screen display 70 as shown in FIG. 10A, the mail browsing application is activated, and the entire display area of the window is used to display a received mail message.

Next, in the screen display 71 as shown in FIG. 10B, since the mail creating application is activated, windows of the two applications are displayed as a split screen. Here, the mail browsing application is visible and inactive, and the mail creating application is currently used and thus is visible and active.

Here, when a predetermined period of time t1 has elapsed since the vertically split windows related to the two applications were displayed (refer to FIG. 10B) with the mail creating application being activated in addition to the mail browsing application, the CPU 47 switches the visible and inactive display area of the window 77 related to the mail browsing application from the normal power mode to the power saving mode 1, and displays information on the mail browsing application (“currently browsing received mail” in this case) on the window 77 (refer to FIG. 10C).

Furthermore, when the predetermined period of time t2 has elapsed since the information on the mail browsing application was displayed (the screen display 72), the CPU 47 switches the visible and inactive display area of the window 77 related to the mail browsing application from the power saving mode 1 to the power saving mode 2, and completely switches the window 77 to black display (refer to FIG. 10D).

In this way, according to the present invention, when a plurality of applications are activated, and multiwindow display is performed, the display area of the window related to the visible and inactive application is switched to the power saving mode 1 (the power saving screen with characters), and is thereafter switched to the power saving mode 2 (the complete power saving screen); therefore, it is possible to notify the user of a state of the application at a glance, the user having forgotten the state of the visible and inactive application as time elapses, while achieving power-saving; and in a case in which a visible and active application is being used for a long time period, it is possible to achieve complete reduction of power consumption for the display area of the window related to the visible and inactive application.

In the present embodiment, the organic EL display unit 21 is configured such that the display area is vertically split into a plurality of display areas, the display window related to the application A is displayed on one of the split display areas, and the display window related to the application B is displayed on another one of the split display areas; however, it is not limited to this configuration. For example, the organic EL display unit 21 may be configured such that a part of the display window related to the application A and a part of the display window related to the application B are superimposed with each other to be displayed. In this case, among the display window related to the application A and the display window related to the application B, a display window in the active state is displayed on the upper layer side, a display window in the inactive state is displayed in the lower layer side, and a part of the display window in the inactive state is covered with the display window in the active state.

Moreover, although a description has been provided using the organic EL display unit 21 as a display unit in the present embodiment, it is not limited thereto, and it may be an LCD (Liquid Crystal Display) or the like. By applying the present invention to an LCD, partial power-saving of the display image is performed, and thus the useful life of the liquid crystal can be lengthened. In addition, characters displayed in the power saving mode 1 are not limited to those described in the first and second embodiments, and may be characters that enable easy confirmation of a state of a visible and inactive application. Furthermore, although a description has been provided in the present embodiments using the cellular telephone device 1 as an electronic device, it may be a device that displays multiwindow, and may be a PDA (Personal Digital Assistant), a notebook PC, an electronic device or the like employing a touch panel method configured with Electro Luminescent Display, LCD or the like.

1. An electronic device comprising:
a display unit;
an operation unit;
an application control unit that controls activation of a plurality of applications; and
a display control unit that displays, on the display unit, a display window related to the application activated by the application control unit,
wherein the display control unit includes:
a first control unit that displays a first display window for a first application and a second display window for a second application when the first application and the second application are activated by the application control unit, and displays one of the display windows in a first power saving state in relation to another of the display windows when any one of the first display window and the second display window is in an inactive state; and
a second control unit that cancels display of the one of the display windows in the first power saving state when the one of the display windows is displayed in the first power saving state, and a predetermined operation is performed to the operation unit.

2. The electronic device according to claim 1,
wherein the display control unit displays, on the display unit, information related to an application corresponding to the one of the display windows when the one of the display windows is displayed in the first power saving state.

3. The electronic device according to claim 2,
wherein the display control unit displays, as the information, a name of the application corresponding to the one of the display windows.

4. The electronic device according to claim 2,
wherein the display control unit cancels the display of the information after a first predetermined period of time has elapsed since the one of the display windows was switched to the inactive state.

5. The electronic device according to claim 1,
wherein the display control unit displays the one of the display windows in the first power saving state after a second predetermined period of time has elapsed since the one of the display windows was switched from an active state to the inactive state.

6. The electronic device according to claim 5,
wherein the display control unit displays the one of the display windows in a second power saving state that is a higher level of power saving than the first power saving state after a third predetermined period of time has elapsed since the one of the display windows was displayed in the first power saving state.

7. The electronic device according to claim 1,
wherein the display unit is configured such that a display area thereof can be split into a plurality of display areas, and
wherein the display control unit displays the first display window and the second display window in one area of the plurality of display areas thus split, respectively.

8. The electronic device according to claim 1,
wherein the applications include at least one of a mail creating application, a mail browsing application, and a TV broadcast reception displaying application.

9. The electronic device according to claim 1,
wherein the display unit is an organic EL (Electro Luminescence) display.

10. The electronic device according to claim 9,
wherein the display control unit displays the one display window in the first power saving state by performing black display in the display area of the one display window.

11. The electronic device according to claim 1,
wherein the second control unit cancels the display of the one display window in the first power saving state, when at least one operation among a predetermined order of one or a plurality of keys, a short operation of a particular key, a long operation of a particular key, or simultaneous operations of a plurality of keys, or a predetermined combined operation thereof are performed to the operation unit, as the predetermined operation.
